(19) United States
(12) Patent Application Publication
(10) Pub. No.: US 2020/0402369 A1
(43) Pub. Date: Dec. 24, 2020

(54) SYSTEMS AND METHODS FOR FACILITATING AND AUTOMATING TOURNAMENTS

(71) Applicant: Tournament Kings Incorporated, Arvada, CO (US)

(72) Inventors: Brett Phillips, Denver, CO (US); John Cianci, Denver, CO (US); Jacob Dahlman, Westminster, CO (US)

(73) Assignee: Tournament Kings Incorporated, Arvada, CO (US)

(21) Appl. No.: 16/904,673

(22) Filed: Jun. 18, 2020

Related U.S. Application Data
(60) Provisional application No. 62/863,195, filed on Jun. 18, 2019.
(60) Provisional application No. 62/951,935, filed on Dec. 20, 2019.

(51) Int. Cl. G07F 17/32

(52) U.S. Cl. CPC G07F 17/3279; G07F 17/3225; G07F 17/3244

(57) ABSTRACT

The present disclosure relates to systems and methods for facilitating a gaming environment, including tournament and single or quickmatch play, which comprises one or more bots, modules or APIs for users to create, run, and manage online game tournaments through digital platforms such as Discord, Twitch, iOS, Android and others. The modules/APIs/bots enable a user or administrator to create and/or customize a plurality of tournament features, such as tournament type (single elimination, double, round-robin, swiss), tournament entry (free or paid), tournament game, tournament platform (Xbox, PS, Steam, etc), tournament start requirement (specific time or number of registrants) and tournament rules, among other features and functions described herein.

### CROSS-REFERENCE TO RELATED APPLICATIONS

This application claims the benefit of and priority under 35 U.S.C. § 119(e) to U.S. Provisional Patent Application Ser. No. 62/863,195, filed on Jun. 18, 2019, and U.S. Provisional Patent Application Ser. No. 62/951,935, filed on Dec. 20, 2019, which are both incorporated by reference herein in their entirety.

### FIELD OF THE INVENTION

This disclosure relates to systems and methods for providing automated or semi-automated tournament and gaming platforms, and also relates to systems and methods for ranking, bracketing, competing and advancing through the automated or semi-automated tournament.

### BACKGROUND OF THE INVENTION

Prior art systems and methods for participating in online or virtual tournaments and similar gaming environments suffer from several shortcomings. For example, such systems have limited user interfaces, limit users to the types of games, tournaments or matches that may be played, limit the types of payouts or earnings that may be assigned to a particular type of event, or limit the ability to provide rankings or odds for setting a tournament bracket.

Prior art systems also have significant shortcomings with respect to paid entry competitions, tracking paid entries, receiving the winnings from the paid entries and in general depositing and receiving funds resulting from the game play or competition on the platform. Other systems cannot be distributed across different servers or face difficulties when attempting to invite other players to participate in a group or team setting.

As another example, reference is made to U.S. Pat. No. 9,704,335. While this prior art system provides improved gaming systems, the improvements are limited to use with player terminals that are licensed gaming locations for playing games such as blackjack, poker and other card-based games. There is no known solution for facilitating skill-based or like tournaments, team play or quick match play of other games, particularly for games favored among the fast-growing eSports gaming community.

Recent regulations and restrictions further complicate the operation of online tournament and gaming systems and methods. For example, the European Union (EU) General Data Protection Regulation (GDPR), Regulation (EU) 2016/679, regulates data protection and privacy for all individuals within the EU, and includes data exported from the EU. The GDPR requires organizations to take adequate measures to safeguard the personal data of individuals who come into contact with the organization (i.e., individual consumers). Notwithstanding the GDPR and other recent regulations impacting data privacy, personal data has been lost and/or exploited by frequent data breaches. Due in part to these breaches, consumers have low confidence in sharing data with various organizations. Therefore, it would be advantageous to provide an online tournament or gaming platform that provides a secure and well-regulated system for depositing, allocating, transferring and tracking funds for use in an online tournament or match play between two or more users of the system, and that otherwise protects against loss of personal data.

It would also be advantageous to provide a system and method for facilitating multi-user gaming and tournament play that greatly reduces, if not eliminates, the additional shortcomings and problems noted above. Other advantages over the prior art will become known upon review of the Detailed Description and drawing figures.

### SUMMARY OF THE INVENTION

With the foregoing in mind, the applicant has invented systems and methods for organizing and participating in an online tournament or gaming environment which, among other things, overcome the disadvantages recited above. Various embodiments described herein broadly relate to systems and methods for registering, inviting, enrolling, ranking, bracketing, scheduling, matching, pairing, competing, score reporting, dispute resolution, advancing, depositing and/or receiving funds from an individual or team via one or more applications or Application Programming Interfaces (“API”).

In embodiments, the systems and methods described above may comprise an application or API. In one embodiment, the application/API may comprise one or more data sets, tables or databases, including one or more relational databases. Databases may contain tournament and/or user specific information and records relating to current and/or past tournament performance, user revenue, relevant statistical analysis, etc.

The application may be provided via one or several modules. In one embodiment, the application/API are designed to operate on a mobile device or mobile computer, and assist a user or administrator with managing a tournament or subsequent actions desired or required following participation in a tournament.

According to embodiments, the system may comprise multiple bots, application modules or APIs for allowing individuals through a variety of digital platforms, such as Discord, Twitch, iOS or Android, etc., to create, run, and manage online games, tournaments or single matches. The modules/APIs/bot(s) preferably allow a user or administrator to create and/or customize a plurality of tournament features, such as tournament type (single elimination, double, round-robin, swiss), tournament entry (free or paid), tournament game, tournament platform (Xbox, PS, Steam, etc), tournament start requirement (specific time or number of registrants) and tournament rules, among other features and functions described herein.

The bot(s) in certain embodiments guide one or more users and/or registrants through payment processing and authorization gateways to ensure fees are appropriately paid for participating in a tournament and winnings may be paid out. After registrants are successfully registered, the bot(s) are configured to provide messaging with the participants and provide instructions, commence a tournament, display a bracket, facilitate progression through the tournament, handle disputes with a tournament creator and pay out the winner(s). In embodiments, the systems and methods are performed automatically or semi-automatically. The bot(s) may also integrate with live streaming platforms to allow for registration, notify about other registrants, and announce winners on the server owner's stream.

In one embodiment, the application/API/bot includes rankings, seeding, odds-setting, gaming or gambling parameters, prop betting procedures, results, payouts, cashouts and/or other functions associated with the gaming and tournament activities conducted using the system.

In one embodiment, the application/API/bot includes time and/or record-specific alerts and/or notifications.

In embodiments, the applications/APIs/bots further permit a user to sort, search and modify records and thereby add or revise data associated therewith.

In embodiments, one or more of these advantages of the system are automated, or performed at least semi-automatically.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatically” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “machine-readable media” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a flexible disk, hard disk, magnetic tape, or any other magnetic medium, magneto-optical medium, a CD-ROM, any other optical medium, a RAM, a PROM, an EPROM, a FLASH-EPROM, a solid state medium like a memory card, any other memory chip or cartridge, or any other medium from which a computer or like machine can read.

When the computer-readable media is configured as a database, it is to be understood that the database may be any type of database, such as relational, hierarchical, object-oriented, and/or the like. Accordingly, the invention is considered to include a tangible storage medium and prior art-recognized equivalents and successor media, in which the software implementations of the present invention are stored.

The terms “determine”, “calculate”, and “compute,” and variations thereof, as used herein, are used interchangeably and include any type of methodology, process, mathematical operation or technique.

The term “module”, “bot” or “API” as used herein refers to any known or later developed hardware, software, firmware, machine engine, artificial intelligence, fuzzy logic, or combination of hardware and software that is capable of performing the functionality associated with that element. Also, while the invention is described in terms of exemplary embodiments, it should be appreciated that aspects of the invention may be separately claimed.

This Summary is meant to be illustrative of the principles and various embodiments of the present disclosure. Numerous variations and modifications will become apparent to those skilled in the art once the full disclosure, including the drawing figures, are appreciated. This Summary is therefore intended to provide a general description of embodiments of the present disclosure, and it is to be expressly understood that the foregoing be interpreted to embrace all variations and modifications disclosed herein.

### BRIEF DESCRIPTION OF DRAWINGS

These and other objects, features and advantages of the present disclosure will be apparent from consideration of the following Detailed Description in conjunction with the drawing Figures, in which:

FIG. 1 is a flowchart diagram illustrating certain aspects of the present disclosure according to an embodiment;

FIG. 2 is another flowchart diagram illustrating certain aspects of the present disclosure according to the embodiment of FIG. 1;

FIG. 3 is another flowchart diagram illustrating certain aspects of the present disclosure according to the embodiment of FIG. 1;

FIG. 4 is another flowchart diagram illustrating certain aspects of the present disclosure according to the embodiment of FIG. 1;

FIG. 5 is another flowchart diagram illustrating certain aspects of the present disclosure according to the embodiment of FIG. 1;

FIG. 6 is another flowchart diagram illustrating certain aspects of the present disclosure according to the embodiment of FIG. 1;

FIG. 7 is another flowchart diagram illustrating certain aspects of the present disclosure according to the embodiment of FIG. 1;

FIG. 8 is another flowchart diagram illustrating certain aspects of the present disclosure according to the embodiment of FIG. 1;

FIG. 9A is a flowchart diagram illustrating additional aspects of the present disclosure according to one embodiment; and

FIG. 9B is a flowchart diagram illustrating yet additional aspects of the present disclosure according to another embodiment.

It should be understood that, in certain instances, details that are not necessary for an understanding of the invention or that render other details difficult to perceive may have been omitted in the drawing Figures. It should be understood, of course, that the invention is not necessarily limited to the particular embodiments illustrated in the Figures, and includes all variations and modifications described herein.

### DETAILED DESCRIPTION

The present disclosure has significant benefits across a broad spectrum of endeavors. It is the Applicant's intent that this specification and the drawings appended hereto be accorded a breadth in keeping with the scope and spirit of the disclosure and various embodiments disclosed, despite what might appear to be limiting language imposed by specific examples disclosed in the specifications. To acquaint persons skilled in the pertinent arts most closely related to the present disclosure, preferred and/or exemplary embodiments are described in detail without attempting to describe all of the various forms and modifications in which the novel devices, systems and methods might be embodied. As such, the embodiments described herein are illustrative, and as will become apparent to those skilled in the arts, may be modified in numerous ways within the spirit of the disclosure.

The accompanying drawings, which are incorporated in and constitute a part of the specification, illustrate embodiments of the disclosure and together with the general description of the disclosure given above and the detailed description of the drawings given below, serve to explain the principles of the disclosure. It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein.

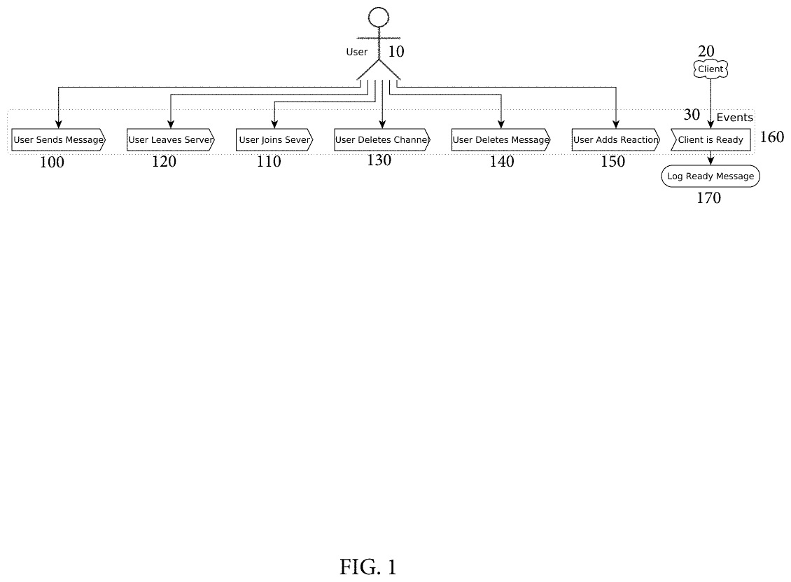

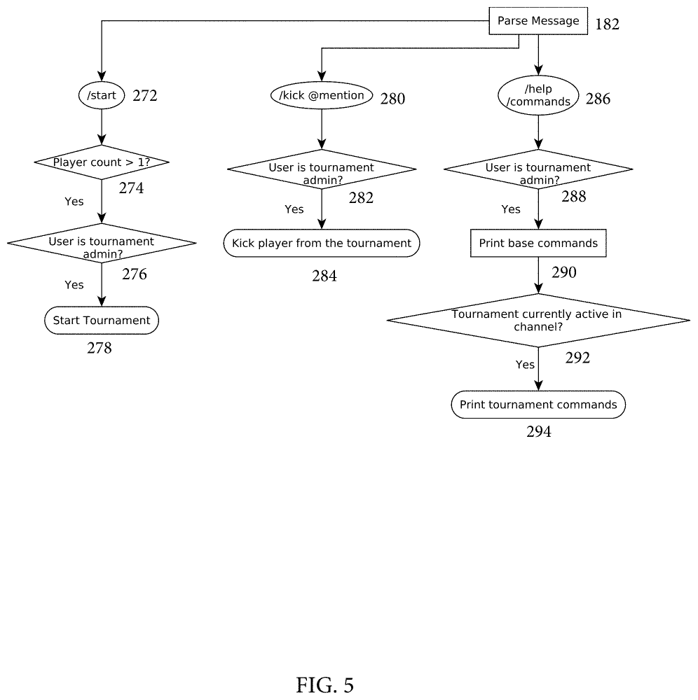

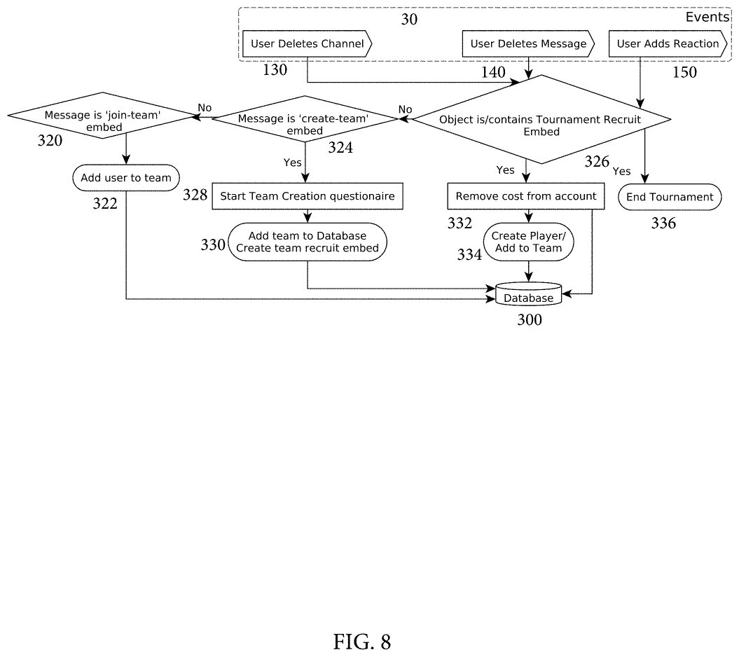

Various aspects of the present disclosure are illustrated in FIGS. 1-9B. In the drawings, FIGS. 1-8 illustrate interrelated flow diagrams of the system and method in accordance with an embodiment of the present disclosure. According to embodiments, a user may register for participation in a tournament through, for example, a mobile application or website affiliated with the systems described herein. The process of registration of a user through the mobile application or website typically requires the user to provide account information, such as a login and password, which permits connection between the user and one or more APIs. APIs include, by way of example but not limitation, a tournament platform API and a Discord API.

Other users of the system and method described herein may utilize the Discord API to organize, manage and execute tournaments. For instance, a user may install the Discord API on a server, such as a user-owned server, and thereby create a tournament. The creation of a tournament may entail several subprocesses, such as defining a tournament through rules and/or procedures for other users to join and/or participate in the tournament. The tournament creator may customize payment processing (for example, Square, PayPal or equivalent) check-out page and send (or otherwise make available) to users to facilitate joining a particular tournament. The user may also create multiple tournament Discord channels, permitting access to the tournament platform and Discord API.

In embodiments, and referring to FIG. 1, the system is hosted at least in part on a virtual private server. When the system is accessed by a user 10, the user 10 may log a ready message 170 through the application/API. Once the ready message 170 is received and the user 10 is in the ready state 160, the user 10 may utilize the system and complete one or several of the application's functions or events 30 described herein.

If the user 10 has previously accessed the application/API, the user 10 may already have an account where their information is stored, including any information about ongoing tournaments. If no account has been established, the user 10 is prompted to set up an account. If a user 10 leaves the server 120 before interacting with the application, no action is taken.

In one embodiment, the ready message 170 is received by a platform such as, by way of example but not limitation, the Discord platform 244. According to this embodiment, once Discord 244 receives the ready message 170 the application is configured to send one or more web hooks, which in turn allow a user 10 to interact with the system. A web hook, according to the present disclosure, provides integration between the system and Discord 244 that allows two-way communication between the system and Discord 244. Thus, as Discord 244 transmits event or other messages (for example, when Discord 244 receives an action) the application receives those messages from Discord 244, which in the form of: sending a message 100; joining the server 110; leaving the server 120; deleting channels 130; deleting a message 140; or other messages, such as adding a reaction 150.

Similarly, a user 10 may send a message 100 through the system such that the application knows when a user leaves the server 120, when the user joins a server 110, when the user deletes a channel 130, when the user deletes a message 140, or when the user submits an emoji or other reaction 150 to any of the messages in that server.

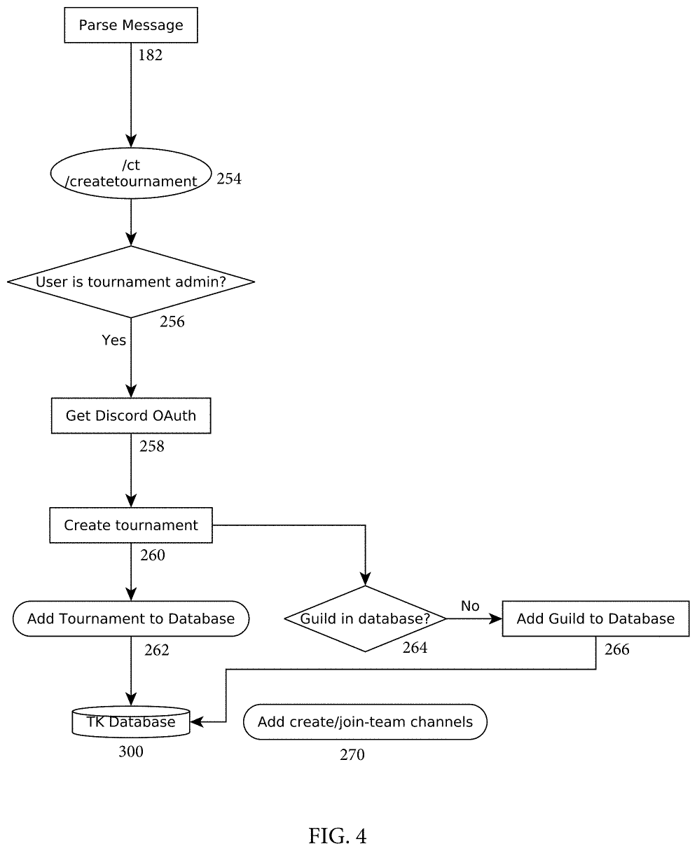

Once a user 10 has logged as ready 170 and the system confirms a ready message, the application/API may then be downloaded or installed on the user's server. This in turn allows the user 10 to interact with the application/API. The user 10 may be provided with a variety of shortcut commands (i.e., commands utilizing a forward slash “/” command), including the Discord commands illustrated in FIGS. 4-7, such as:

“/ct” or “/createtournament” 254 for creating a tournament;

“/team setup” 240 for setting up a team;

“/start” 272 for starting a tournament;

“/qm” or “/quickmatch” 296 for creating a quickmatch

“/score” 212 for entering or overwriting a score (e.g., within a tournament);

“/refresh” 220 for refreshing a bracket (e.g., for a specific tournament);

“/playercap” 228 for changing the number of participants;

“/support” 236 for linking to a support server associated with the system;

“/ban” 248 for banning select participants;

“/kick” 280 for kicking select participants from the tournament;

“/help” or “/commands” 286 for receiving help with or a listing of the commands;

“/end” 310 for ending a tournament; or

“/feedback” 316 for providing feedback about the system.

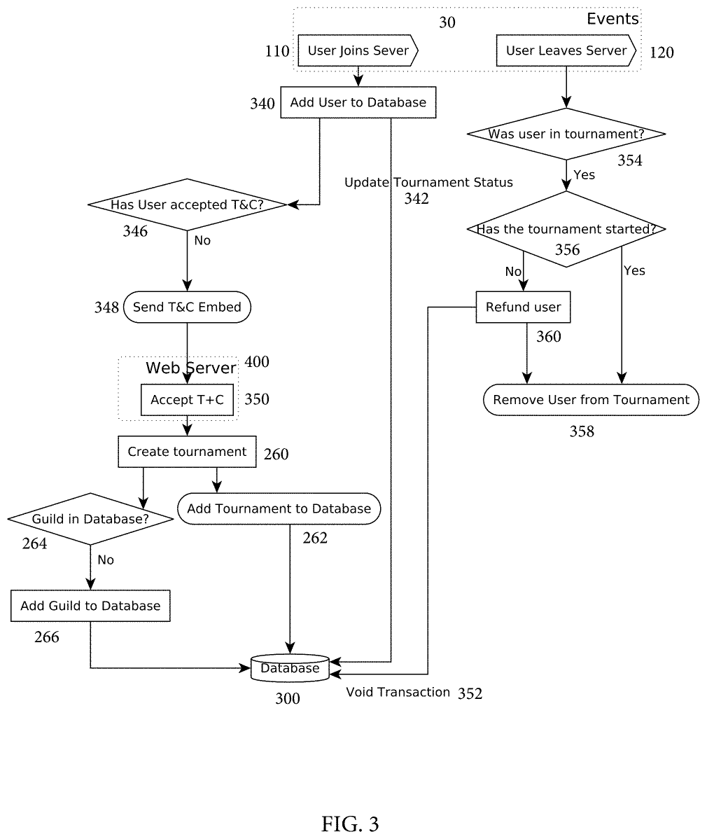

It is expressly understood that while the following commands are pertinent to Discord 244, other platforms may entail alternate commands and prompts without deviating from the inventive aspects claimed herein. For example, when a user 10 types “/createtournament” or “/ct” 254 in Discord 244, the user 10 may be placed directly in a tournament creation subroutine (illustrated in FIG. 3). The user 10 is preferably granted permission to create a tournament if they have been assigned the role of tournament administrator 256, have been designated as an administrator of a server, digital platform, or otherwise permitted to make such changes. If a user 10 has never used the system before, the application/API directs the user 10 to a “terms of service” subroutine 346. Under this subroutine, the user 10 is sent an embedded message 348 with details on how to accept the system's terms and conditions 350. In embodiments, the user 10 may be redirected to a hosted website or web server 400, which allows the user 10 to accept associated terms and conditions 350. The system then checks whether the user 10 is in the database 300 associated with the system, which is described in greater detail below.

### Tournament Creation

Once a user 10 is confirmed to have accepted the terms of service, the user 10 may proceed with further commands, such as creating a tournament 254 or quickmatch 296. Additional details are illustrated in FIGS. 3, 4 and 7.

Tournament creators may also establish limits on the number of users 10, such as a player cap 228, who may participate or a sunset time period for closing entries into a particular tournament. A tournament bracket may be generated and made available on the tournament platform for others to observe and/or join. When a user 10 creates a tournament, a tournament bracket is not typically created yet. The user 10 can create and select delivery of a “recruit message” detailing the tournament and inviting other users to join or participate in the tournament.

The user 10 may interact, joins the tournament or declines to join the tournament by reacting 150 to an “emoji” included with the recruit message. The recruit message may comprise one or more preloaded emoji reactions, wherein users 10 in the system who receive the recruit message may join the tournament before the event starts. The specific emoji may be a play button arrow, for example, but in other embodiments are different types of emojis or, in alternative embodiments, non-emojis.

The tournament is preferably created by a user request routed to a tournament creation API. The system provides a user 10 with a list of eligible participants in the tournament, the style of tournaments (i.e., single elimination, double illumination, etc.), any finals qualifiers or modifiers (i.e., whether to have a series as the tournament final or a single match), other rules or conditions placed on the tournament and its participants. Once the tournament creation API is completed, the data is routed by the tournament creation API to the system for creating a tournament bracket. The bracket is then populated with the participants selected and accepted from the recruit messaging.

Once a user types the “/start” command 272, the field of users 10 entered into the tournament is typically locked and a bracket is created automatically by the system. Each user 10 who joined the tournament before the start of the tournament is assigned a place in the bracket. Participants in the tournaments view the bracket and participate in their matches, outside of the system. However, as described in greater detail below, the participation in individual or tournament matches may occur within the tournament platform, thereby facilitating entry and tracking of match results and advancement of players in the tournament.

### Public and Private Tournaments

Tournaments may be public or private, and limit participation to certain users accordingly. In this manner, a tournament may be created and managed by a user 10 simply by installing the Discord API and defining tournament characteristics for other users to subscribe. For example, an administrator may select either a public or private tournament based on a togglable field presented to the administrator upon creation of the tournament. The field selection and tournament is then stored 262 into the system database 300. When another user 10 attempts to access the tournament, the system will query the database 300 to determine if the tournament is a public or a private event. If the tournament is a public event, the event will be displayed on public pages of the tournament platform. However, if it is a private tournament, the event may only be displayed privately to users 10 that have been specifically invited by the administrator.

When accessing and creating a tournament through the Discord API, the system may reflect an administrator's selection of a private or public channel through Discord 244. However, if the administrator creates a tournament outside of Discord 244 or via a different platform, the administrator may be provided with a toggleable field with the option of selecting public or private for a particular tournament. Alternatively, if a user 10 needs a specific role to interact with the API (e.g., as the tournament administrator), the tournament creator may have the ability to initially assign roles that would be transferred from the tournament creation API to the system database 300. The database 300 retains the list of roles for a specific server owner or tournament. The API then queries the database 300 when a certain permission is requested by a user 10 within a tournament to see if the roles in the database match what has been requested by the user 10. If permitted, the requested action would be taken by the API just as if the administrator had requested the action.

Returning to the Discord API tournament creation routine, all publicly accessible tournaments are directed and displayed according to the Discord 244 server and the particular public channel 270 added by or associated with the tournament administrator or server owner. The server owner, as that term is used herein, refers to the person who established the server (i.e., via Discord 244), and are the first administrator of the server. The server owner may delegate responsibilities to other people, and in general are able to restrict who can view or receive data accessed via their server using a role-based access control system.

For example, the tournament creation API may incorporate a “role” called tournament admin. The tournament admin role is recognized by the tournament bot as somebody who can interact with the bot that isn't an administrator of the Discord server. If the user is the owner or administrator of a Discord server, but doesn't want to allow others to administer their server (rather, simply administer the commands of the API and/or the particular tournament), the administrator may assign the tournament admin role to another 256, who will then be able to interact with and control the API as if they were the administrator.

The administrator or server owner may send a general recruit message in order for other users 10 to join the tournament, which makes the message public. If the channel 270 that the message is created in is private, however, only a select few users 10 who are authorized to view that private channel can receive the recruit message and are thus able to join the tournament.

Once registered, and presuming the user 10 has permission to join a particular tournament, the user 10 may join a tournament offered through the application/API. One or several tournaments may be joined simultaneously. As long as at least one other user 10 has been also added to the tournament 274, the users are seeded and the tournament started 278. Ranking and odds for a particular tournament are described in greater detail below.

Joining a particular tournament may be limited by a set number 228 of users 10 or a time frame for joining the tournament. Depending on rules, conditions or administrative controls, the tournament field is closed. The tournament may then proceed, with users 10 paired against other users 10 as set by the tournament rules until their match is completed.

Outcomes of the match may be reported through various user facing interfaces, including but not limited to the application/API, by users 10 or the tournament administrator. Winners of the match(es) advance to a subsequent round and face other users 10 in the tournament until a champion is determined. Once a match or round of matches is finished, the seeding may be reevaluated and/or bracket restructured, depending on the tournament rules and conditions, for the tournament.

Once all set matches are completed, and any disputes are resolved, a tournament winner is announced, and the tournament preferably ends. If it is a paid tournament, winnings are then transferred to the winner's account, and the winner can cash out via a payment processor (i.e., Square, PayPal or equivalent payment method).

### Free and Paid Tournaments

If a free (i.e., no fee) tournament is created, the players in the tournament progress through the matches and bracket pursuant to the tournament rules and conditions until a champion is crowned. The system accepts reported scores 212 and updates the bracket 224 each time a match is completed and a winner is determined, until the final round is completed. On completion of the final round the API routes a message to the tournament administrator(s) prompting the administrator(s) to finalize the tournament. The tournament administrator may then type a command, such as “/end” 310 to commence a tournament finalization process or subroutine 314 through the API.

If the tournament is completed the system determines the winner, second place, third place and other ranking participants in the tournament, then creates a message displaying the final ranking of those players. Additional information may be provided, including the length and ancillary results or outcomes of the tournament, a final image of the bracket, the placing of players, etc. The players may also be provided with a field for providing feedback 316 on the tournament.

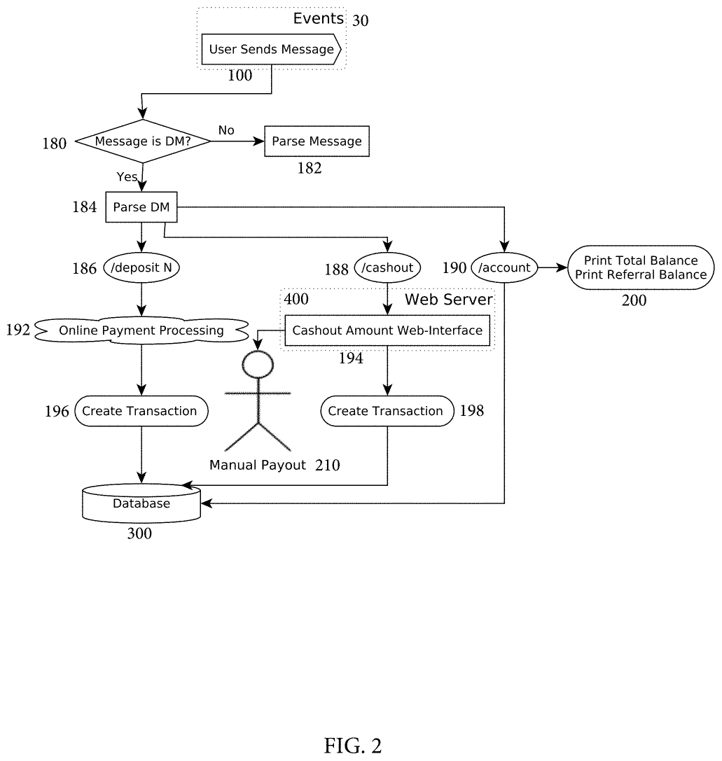

Referring to FIG. 2, if a user 10 is participating in a paid tournament (i.e., if there is a payment due upon entrance into the tournament), the system preferably comprises an additional API to determine if the user 10 possesses enough funds to enter the paid tournament. This is achieved by accessing the database 300, where the system stores transactional data subject to a structured query for determining the amount of funds deposited into a user's account 190. If the query determines that the account has a balance exceeding the entrance price for the tournament, then the user 10 is allowed entrance into the paid tournament. If they do not have enough funds to participate, the API recognizes the deficiency and generates a message to the user 10 stating that the user 10 needs to deposit 186 at least the amount needed to cover the difference between the account balance and the minimum fee payable to enter the tournament. Once the additional fee is paid 192, 196, the user 10 may successfully enter the paid tournament.

During a paid tournament, users 10 preferably report their scores and the match winners are determined. Each match progresses automatically. In certain paid tournaments, the payout 188 may be made during individual rounds of the tournament. Thus, as a user 10 wins a match that user 10 will be paid 198 for each win. In other tournaments, the payout 188 may be conditioned on a user 10 becoming one of the top performing users 10 in the tournament, such as the winner of the tournament, second place, third place, etc. Once the tournament has been finalized, the API will determine payout(s) 188 according to the tournament rules. In this style of tournament, the administrator must finalize the tournament before the calculation of how much each user 10 has earned can be made. Once payouts 188 are made, the corresponding transactions are reflected in the database 300 and the balance reduced from the payout pool.

Upon logging the payout transactions 198 in the database 300, the system routes a message to inform the user(s) 10 of those transactions 198 and records the deduction of the amount of money from the payout pool. Referring to FIG. 3, if the user 10 leaves a tournament 354 prior to the start of the tournament 356, the system registers a new transaction and refunds the user 10 their entry money 360. However, if the user 10 leaves after the tournament is started, a transaction 358 may occur forfeiting the entry money to the payout pool, depending on the rules and conditions of the tournament.

### Rolling Payout Structure

While a tournament administrator or other user 10 may choose to implement a traditional payout structure (i.e., where final standings determine the payout, including winner-takes-all, top 2, etc.), the system also permits a rolling payout structure (i.e., where every win in a tournament earns the player certain funds available from the payout pool). In this type of structure, each round victory comes with an increasing payout percentage of the prize pool. For example, a 1st round victory may come with a payout that is 1% of the prize pool, a 2nd round may come with a payout that is 10% of the prize pool, and so on. Each round payout amount or percentage payout may be customizable by the Tournament administrator, within the restriction that the total round payouts equal no more than 100% of the prize pool.

In addition to the percentage of the prize pool rolling payout structure, this type of payout structure may also be used for non-currency prize or incentive distribution. For example, a 1st round victory may come with a 5% coupon code, a 2nd round victory may come with an in-game skin redemption code, and so on. This system can be used for both traditional cash prize pool tournaments and non-currency prize pool tournaments.

### Team and Match play

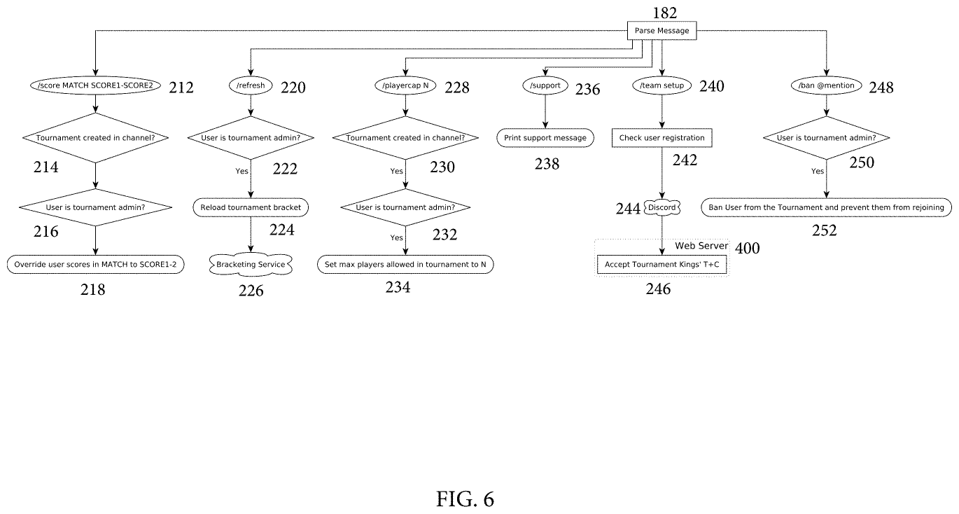

Referring to FIGS. 6-8, a tournament administrator may also set up teams using the /team commands 240. A team is a different category of tournament play and may apply to certain channels 270 (such as Discord channels) wherein any participant in the particular server may interact with other participants to create a team or join an existing team. For example, in the team creation channel 270 there may be an embedded message which permits a user 10 to react to an emoji 150, which enters the user 10 into a dialogue 324, 328 with the API. The dialog preferably asks for a team name, a team size (number of participants), information relating to any sponsoring organizations, uploading of a photo or logo for the team, and a short team “tag” for use identifying the particular team.

After a team is created, according to embodiments, any user 10 may request to join a team 320, provided the creator approves the request. The participants of the team are placed into a joint team channel 270, wherein each team preferably has their own messaging framework within that channel. The system therefore allows any user 10 on the server to join a team 320, so long as it is not fully at the maximum capacity. A user 10 may also leave a team. Once a full team is assembled, the team may enter a tournament by, for example, reacting to a recruit message 330 emoji. The system then creates a registration for every member of the team 322, and if the tournament is a paid tournament, debits each team member's account balance 332 by the required entry fee. The database 300 records transactions for each individual member in the manner described above with respect to individual member tournaments. Each team progresses as a single entity through the tournament, with winners and champions determined as described above.

### Quickmatch Play

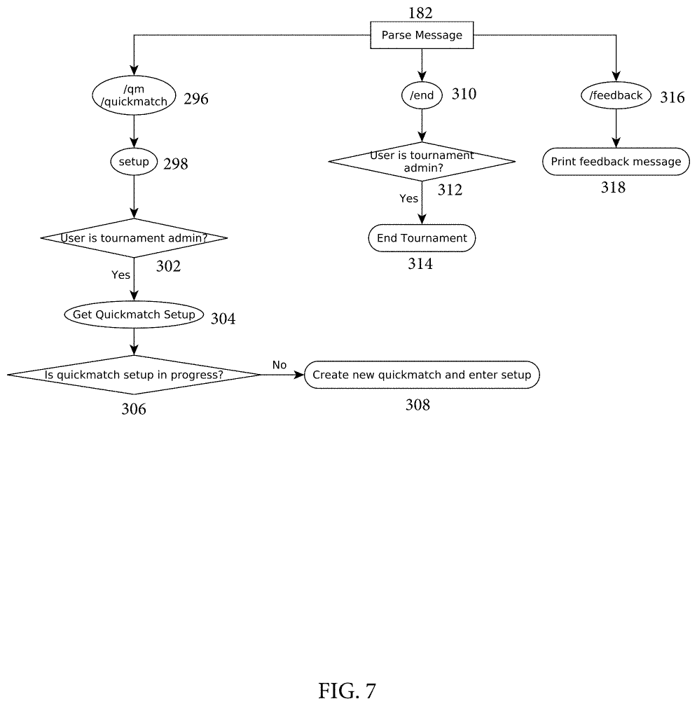

Referring to FIG. 7, the administrator or server owner, or in certain embodiments any user 10, may create a different type of match play referred to herein as a “quickmatch” 296. The quickmatch 296 is similar to the team feature, in that it is separate from the typical tournament creation API. Under this model, a user 10 may create a “quick match” 296 competition separately from any tournament or team event. For example, a user of the server may create one or more “quickmatches” by entering a “/qm” or “/quickmatch” 296 command in Discord, by way of example. The system may alternatively provide a platform for users 10 having the proper permissions to set up channels for creating a “quickmatch” 296 and may be referred to as a quickmatch channel. The channel may be subdivided into a free quickmatch channel or a paid quickmatch channel. In other embodiments, the team functionality is used for both quickmatches 296 and tournaments, wherein the creation of a team facilitates the entry and participation in a quickmatch 296. The platform preferably provides users 10 with the ability to create and compete in a quickmatch with any other user 10.

In the quickmatch 296 setting, results and disputes can be provided and resolved in a similar fashion as described above. Depending on the roles and permissions given by the administrator(s) 298, users 10 may be able to interact with these quickmatch channels such that anyone can create a “quickmatch” with any other participant of that channel. A quickmatch competition is initiated by sending a quickmatch message, and the user 10 on the receiving end reacting to the message (or by accepting a challenge through a quickmatch channel). Once the user 10 reacts to the message, the API serves up a direct message dialogue interface with the parameters of the quickmatch (i.e., the type of game, how many rounds are to be played, whether it is a free or paid event, and any rules or conditions placed on the participants of the quick match).

Assuming a user 10 accepts the quickmatch message, another message is sent to the creator of the quickmatch indicating that the user 10 is trying to join the quickmatch. The message provides the creator a preset amount of time to accept the challenge, and if accepted the creator of the quick match and the other user 10 may start the quick match.

The creator of the quickmatch reports the score using a “/score” command 212. After the score is entered, a message is generated for the opponent to verify. The opponent may dispute the score if incorrect, or confirm the score. If the score is disputed, the match is moved to a disputes channel where only administrators of the server can access the quickmatch 296. The administrators who have access to that channel are able to confirm or refute the results of the match, including by collecting information from the participants of the quickmatch 296.

Any funds, in the event of a paid quickmatch 296, are distributed automatically to the victor of the match. The match card may be displayed on a results channel for anyone else permitted to view that channel and observe the results of the quickmatch 296.

### Scoring and Payouts

Once matches within a tournament or a quickmatch have been completed, the user 10 or administrator may report their score 212 and the system will update the bracket 224 or competition with those scores. Therefore, updates and progress are visually displayed through the bracket, based on the results that are reported 226. In the case of a dispute, users are able to contact (via messaging or otherwise) the tournament administrator, present evidence supporting their dispute, and formally dispute the score. The tournament administrator is then authorized to receive the evidence and determine the correct outcome of the match, and ultimately overwrite the score using the “/score” command 212.

Payouts 188 require additional account information to be registered by the user 10. Once the account information is retrieved, the user 10 is validated for accepting payment and receiving payouts 188. The registration process may also entail the creation of a provisional user account 190 on the tournament platform, and may redirect the user 10 to complete a further registration process via the tournament platform. Completing the registration process preferably directs the user to a payment processor 192 for payment of tournament entry fees and checkout.

At any stage of a tournament or quickmatch 296, a user 10 is able to access their financial information through direct messages by typing in the /account command 190 which will provide the user with all of the stored information for that user, including their total balance, any promotional balance or pending credits/debits 200, etc. If the user 10 desires, they may deposit more money in their account by using the /deposit command 186 and indicating the amount of money that they wish to deposit. The system provides a secure processing portal 192, which may utilize the payment processor's API. Upon successfully depositing money through the secure processing portal, a deposit transaction 196 is reflected in the system's database 300.

If the user wants to cash out, the user may use the “/cashout” command 188. Once invoked, the user is preferably redirected to a secure web interface 194, which may reside on a web server 400, and enter the amount the user 10 wants to withdraw. The system confirms that there are enough funds in the account to credit to the user 10, and then creates a transaction in the database for the requested withdrawal. For example, the withdrawal of funds may result in payment as directed by the user via PayPal. The user 10 may be directed to provide a specific PayPal email, which may be different than the email of record for their account. The user 10 may also indicate manual payment 210, including to someone else, by providing a different PayPal account.

In an alternate embodiment, the system uses one or more public APIs to ensure that scores are reported automatically and correctly. The “/dispute” command may also provide a user with a mechanism to alert the tournament administrator of a participant cheating, or to report fraudulent or improper behavior by a participant.

While the gameplay described above occurs independent of the system and associated APIs, in alternate embodiments the gameplay may integrate with an actual API from the specific game's developer. In this scenario, there is no longer the need for self-reporting of scores. Instead, results are automatically pulled from the game developer's API and tournaments updated automatically once a match is completed. This alternate embodiment may significantly reduce or eliminate any disputes over score reporting.

### Database

The database 300 preferably comprises multiple tables. The first table in the database 300 is the user table, which may comprise information about every person who has signed up for an account with the system, or has interacted with the system in general. This table stores information related to the users' digital identities and any specific IDs associated with the different APIs.

The database 300 also preferably comprises a tournament table, which contains all of the data needed to separate the tournaments and identify the tournaments, including the different characteristics that are unique to each tournament. This table includes, for example, the name of the tournament, the amount of people in the tournament, the date and time the tournament started, the winner, each of the channels and messages that are associated with the tournament, and any history related to the tournament (i.e., finalized, completed, payout, etc.).

Another table is the team table, which may comprise the specific information for unique teams, such as the unique IDs of the captain, the creators, the team members, and any description of the team that makes it unique from the other entries.

The system database 300 preferably comprises a players table, which is used to keep track of everyone who has participated in any system event, including quickmatches and tournaments.

The database 300 may comprise a match table, which contains all the data for what happened within a specific match. If there are multiple matches in a tournament, the match table captures all of the data for all of the matches, including data for any match done in quickmatch as well.

The database 300 may comprise a score table, which captures the score and any modifications made to the score for a match, referenced by a unique ID.

The database 300 preferably comprises a registration table, which is used to verify players entering into an event, whether those players have made the minimum contributions to enter the tournament, or whether the players have sufficient funds to enter the tournament, and a reference to the transactions made to register the players for specific paid events.

Another preferred table is the transactions table. The transactions table contains all financial related information, for every single event on the platform, which includes an entry each time money is deposited, withdrawn, added, debited, credited, and any payouts from the tournament. This table may also comprise any percentage of the winnings deducted by the operator of the system.

The database 300 may comprise a quick match setup table, which preferably contains information regarding the unique IDs for any categories and channels or messages created in a particular server for setting up quickmatches. A quickmatch table may also be provided, which contains unique data for each quick match that is created and completed.

The system database 300 may comprise a guilds table, which preferably contains information about the Discord 244 server(s) that are using the system APIs. The system can track member counts and guild IDs 264 to identify the specific Discord 244 servers or other server owners, and maintain a record of when a member first adds the API 266 to their server, or when the APIs are deleted from their server, for example.

The system database 300 may comprise a team registration table, which includes a ledger that keeps track of what players are joining one or more teams. Any time a player joins a team or leaves a team, an entry is created into this database 300 so the system can determine when somebody has joined or left a team.

The database 300 also preferably comprises a team setup table, which is similar to the quick match set up table, which preferably contains the unique IDs of all the resources created in Discord 244 for the administrator responsible for the team and the team's functionality within their server.

Referring again to the matches table, the database 300 preferably contains all of the data that is used to determine skill, ranking, potential rating and odds that the system determines. The database 300 also contains data relating to the events associated with the matches being played, including whether the event was a tournament or quick match. The database 300 also tracks who won, the ranking position of each participant, whether they reported their scores accurately, how many rounds were completed in the tournament or match, reference to the confirmation provided by the participants or administrator, and the precise score each player/opponent recorded in the specific match.

### Determining Odds/Rankings

One issue that exists in prior art ranking systems is the inability to account for team rankings that accounts for all variables present in a tournament platform. Regardless of which prior art ranking system is being used, the team rankings are greatly oversimplified by relying on the averages across the various team members to provide a single, collective ranking system amongst the teams. For example, if Lebron James is selected on a team, he is going to make a much bigger impact than another above-average player. Ranking the team that Lebron James is a member of by looking at averages across all team members is far too simple, in part because an individual player of the caliber of Lebron James can make a significantly greater impact than a simple team average would indicate.

The current system and method comprise a novel team ranking system, including a system and method for providing team odds, which take into account extraordinary or exceptional players by giving them a weighted ranking. The system also takes into account other characteristics unique to online gaming environments, including different or unique skill sets, pros/cons, attributes, past performance (i.e., if a player is really good at playing character A, but, not as good as playing character B) and other variables. The system takes each of these variables into account when setting odds and ranking teams, which are based not on simple averages but instead on a multi-attribute methodology to determine likelihood of success or failure.

The system preferably includes additional APIs for generating odds based on who is playing a particular match, who are their teammates, what is that individual teammate playing (as it relates to a character or champion), as well as what other individual teammates are a playing as, and the collective attributes those teammates provide to the team in determining what the overall odds should be. Additionally, when ranking or setting odds, the system may account for play style and other intangibles for a player. For example, if you have one player who likes play defensively, but also have four other players who like to play offensively, then you may not have the same rankings (defensively) across all five players. Therefore, the system also accounts for how well a particular player fits into a specific play style given their specific skill level and attributes. This is particularly important for determining rankings and odds for eSports.

### Honor Ranking

The system may also comprise a procedure for including honor rankings into the system. The honor ranking system also accounts for intangibles, as opposed to just a win/loss record or statistics generated during the game play. The honor ranking will be a way to account for intangibles, including by way of example: how many times you've missed payments; how many times you've been accused of cheating; how many times been proven to have cheated; how many times you fraudulently filed disputes; how many times your score has been disputed; and other intangibles. In setting honor ranking, all or some of those intangibles may impact a participant's honor ranking or may impact a user's ability to use the platform, which will play into the overall odds set for a particular match or tournament.

### Random Prize Distribution

Another novel feature of the bot comprises rewarding users for activity. In one embodiment, the user rewards operate akin to a built-in sweepstakes. For instance, during team creation or other events, including those described in the “Lobby” section below, the bot is configured to randomly generate team names. The bot is configured to select special team names, at a predetermined and controllable rate, which result in the user winning a reward or prize. In certain embodiments, no payment or fee is required for the user to win a reward or prize, and all users are invited to participate. The winning name(s), frequency, and reward/prize may further be customized by a tournament administrator.

### White-Labeling

Yet another novel feature permits a tournament administrator to change the color, images, links, or other information that the bot displays. In this manner, the tournament administrator may customize a player portal or tournament site.

### Lobby

Another novel feature of the system comprises a specific, unique gameplay type, wherein a tournament administrator is permitted to create a “lobby” or virtual room and designate a specific number of users who may enter the lobby. The tournament administrator may provide users with one or more activities within the lobby, including: play a pickup game; a battle royale match; a traditional tournament; chat; organize; etc. The lobby, in certain aspects, is digitally separated from the overall tournament community.

### Free For All

Another novel aspect of the system is referred to as a “Free For All” (FFA), which is a specific type of gameplay. In certain embodiments, the FFA is offered and occurs within a lobby. The FFA gameplay type allows for a population of users (for example, those users in the lobby) to be split up individually, where each user plays against all other users in a specific game. For example, if a tournament administrator has established a lobby having 64 players, and desires to run 8-user FFAs, the bot is configured to split those 64 players into 8 groups of 8 users. Those 8-user groups each compete in the game in a first round. After the first round, the winners of each group advance to the next round against the winners of each of the other 8 groups. The winners will advance until the tournament is complete. Additional rounds or quantities of users are contemplated with the FFA gameplay described herein. This gameplay may be structured for specific games, such as Team Fight Tactics, Chess Rush, and other games.

### Pickup

Another novel aspect of the system comprises an automated version of a “pickup” game. For this function, a pickup game typically starts within a lobby. For example, if there are 10 users in a lobby, and the bot is configured to run matches among teams of 5 users, the bot is configured to automatically pick teams from the available player pool and set up matches for the teams to play. This distribution may be randomized, driven by rankings, or a combination of the two. The teams may select to play additional “pickup” rounds with those same teams (“run it back”) or the bot may select different teams. The lobby size and team size are both customizable, allowing for greater flexibility when configuring the bot's functions.

### Additional Aspects of System

The system described herein may also calculate or determine winnings and payments to multiple participants when, for example, there is more than a single winner for a given tournament. The system may be configured to allow a messaging framework between participants in the tournament and a tournament administrator, such as for scheduling, dispute resolution, or other tournament related inquiries. The system may also be configured to send alerts when payments are owed for participation in a tournament selected by a user 10, or when other information is provided relative to the tournament, such as reseeding or updated bracket results. Variations and modifications to the system and particularly the messaging framework described herein is contemplated.

In embodiments, the systems and methods described above may comprise an application or API. The application may be provided via one or several modules. In one embodiment, the application/modules are designed to operate on a mobile device or mobile computer, and assist a user 10 or administrator with managing a tournament or subsequent actions desired or required following participation in a tournament.

In one embodiment, the application/modules may comprise one or more data sets, tables or databases, including one or more relational databases. Databases may contain tournament and/or user specific information and records relating to current and/or past tournament performance, user revenue, relevant statistical analysis, etc.

In one embodiment, the application includes time and/or record-specific alerts and/or notifications. In embodiments, the application/modules further permit a user 10 to sort, search and modify records and thereby add or revise data associated therewith. In embodiments, one or more of these advantages of the system are automated, or performed at least semi-automatically.

In embodiments, the application is advantageously configured to receive and send information by, for example, a user's mobile device. In one embodiment, the application comprises one or more user interfaces and displays. The application and associated user interfaces may be stored or operated on a computing environment, wherein the systems, devices, servers, modules, etc. may execute. The computing environment preferably includes one or more user computers and/or servers. The computers/servers may be general purpose personal computers (including, merely by way of example, personal computers, and/or laptop computers running various versions of Microsoft Corp.'s Windows and/or Apple Corp.'s Macintosh operating systems) and/or workstation computers running any of a variety of commercially-available UNIX or UNIX-like operating systems.

The user computers/servers may also have any of a variety of applications, including for example, database client and/or server applications, additional APIs and web browser applications. Alternatively, the user computers may be any other electronic device, such as a thin-client computer, Internet-enabled mobile telephone, and/or personal digital assistant, capable of communicating via a network and/or displaying and navigating web pages or other types of electronic documents. Any number of user computers may be supported.

The computing environment described according to this embodiment preferably includes at least one network. The network can be any type of network familiar to those skilled in the art that can support data communications using any of a variety of commercially-available protocols, including without limitation SIP, TCP/IP, SNA, IPX, AppleTalk, and the like. Merely by way of example, the network maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks.

The system in varying embodiments may also include one or more server computers. One server may be a web server, which may be used to process requests for web pages or other electronic documents from user computers. The web server can be running an operating system including any of those discussed above, as well as any commercially-available server operating systems. The web server can also run a variety of server applications, including SIP servers, HTTP servers, FTP servers, CGI servers, database servers, Java servers, and the like. In some instances, the web server may publish operations available operations as one or more web services.

According to certain embodiments, the computing environment may also include one or more file and or/application servers, which can, in addition to an operating system, include one or more applications accessible by a client running on one or more of the user computers. The server(s) may be one or more general purpose computers capable of executing programs or scripts in response to the user computers. As one example, the server may execute one or more web applications. The web application may be implemented as one or more scripts or programs written in any programming language, such as Java™, C, C#, or C++, and/or any scripting language, such as Perl, Python, or TCL, as well as combinations of any programming/scripting languages. The application server(s) may also include database servers, including without limitation those commercially available from Oracle, Microsoft, Sybase™, IBM™ and the like, which can process requests from database clients running on a user computer.

In embodiments, the web pages or equivalent graphical displays created by the application server may be forwarded to a user computer or user mobile device via a web server. Similarly, the web server may be able to receive web page requests, web services invocations, and/or input data from a user computer and can forward the web page requests and/or input data to the web application server. In further embodiments, the server may function as a file server. Although the foregoing generally describes a separate web server and file/application server, those skilled in the art will recognize that the functions described with respect to servers may be performed by a single server and/or a plurality of specialized servers, depending on implementation-specific needs and parameters. The computer systems, file server and/or application server may function as an active host and/or a standby host.

In embodiments, the computing environment may also include a database. The database may reside in a variety of locations. By way of example, database may reside on a storage medium local to (and/or resident in) one or more of the computers. Alternatively, it may be remote from any or all of the computers, and in communication (e.g., via the network) with one or more of these. In a particular embodiment, the database may reside in a storage-area network (“SAN”) familiar to those skilled in the art. Similarly, any necessary files for performing the functions attributed to the computers may be stored locally on the respective computer and/or remotely, as appropriate. In one set of embodiments, the database may be a relational database, which is adapted to store, update, and retrieve data in response to SQL-formatted commands.

The computer system may also comprise software elements, including but not limited to application code, within a working memory, including an operating system and/or other code. It should be appreciated that alternate embodiments of a computer system may have numerous variations from that described above. For example, customized hardware might also be used and/or particular elements might be implemented in hardware, software (including portable software, such as applets), or both. Further, connection to other computing devices such as network input/output devices may be employed.

According to one embodiment, the server may include one or more components that may represent separate computer systems or electrical components or may software executed on a computer system. These components include a load balancer, one or more web servers, a database server, and/or a database. The load balancer is operable to receive a communication from the mobile device and can determine to which web server to send the communication. Thus, the load balancer can manage, based on the usage metrics of the web servers, which web server will receive incoming communications. Once a communication session is assigned to a web server, the load balancer may not receive further communications. However, the load balancer may be able to redistribute load amongst the web servers if one or more web servers become overloaded.

In embodiments, one or more web servers are operable to provide web services to the user devices. In embodiments, the web server receives data or requests for data and communicates with the database server to store or retrieve the data. As such, the web server functions as the intermediary to put the data in the database into a usable form for the user devices. There may be more or fewer web servers, as desired by the operator.

In this embodiment, a database server is any hardware and/or software operable to communicate with the database and to manage the data within the database. Database servers, for example, SQL server, are well known in the art. The database can be any storage mechanism, whether hardware and/or software, for storing and retrieving data.

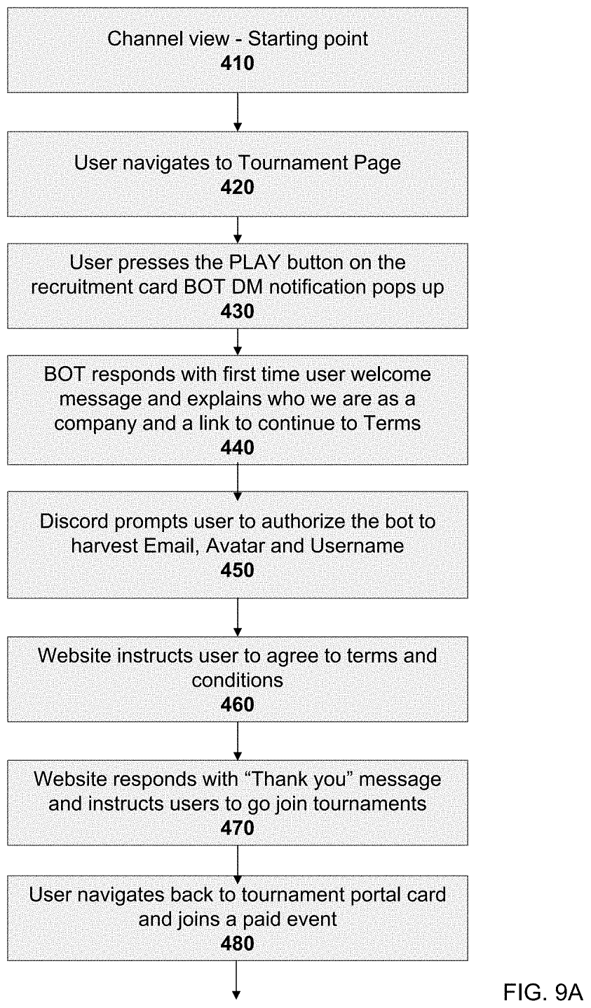

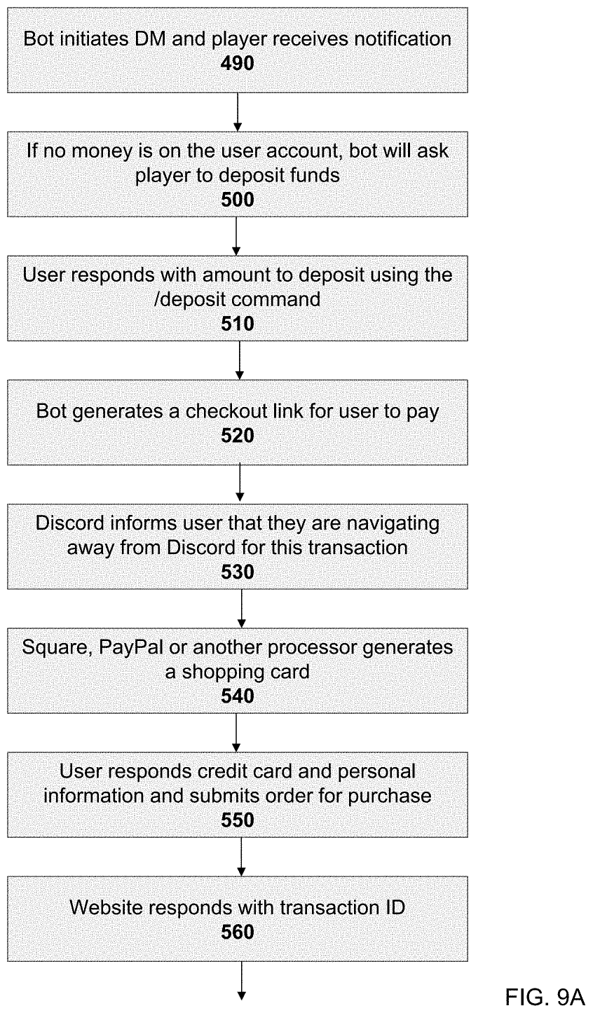

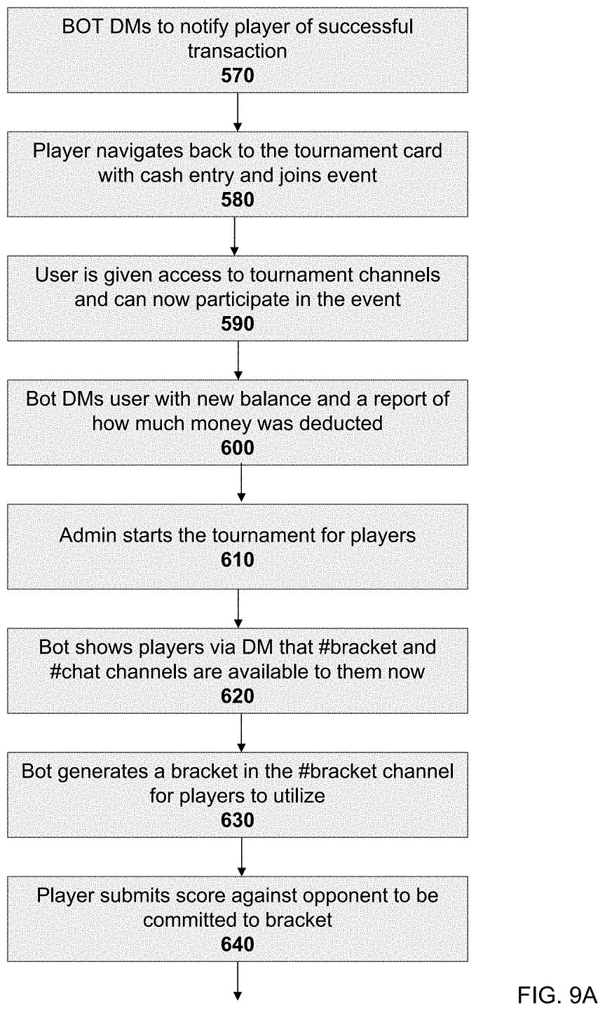

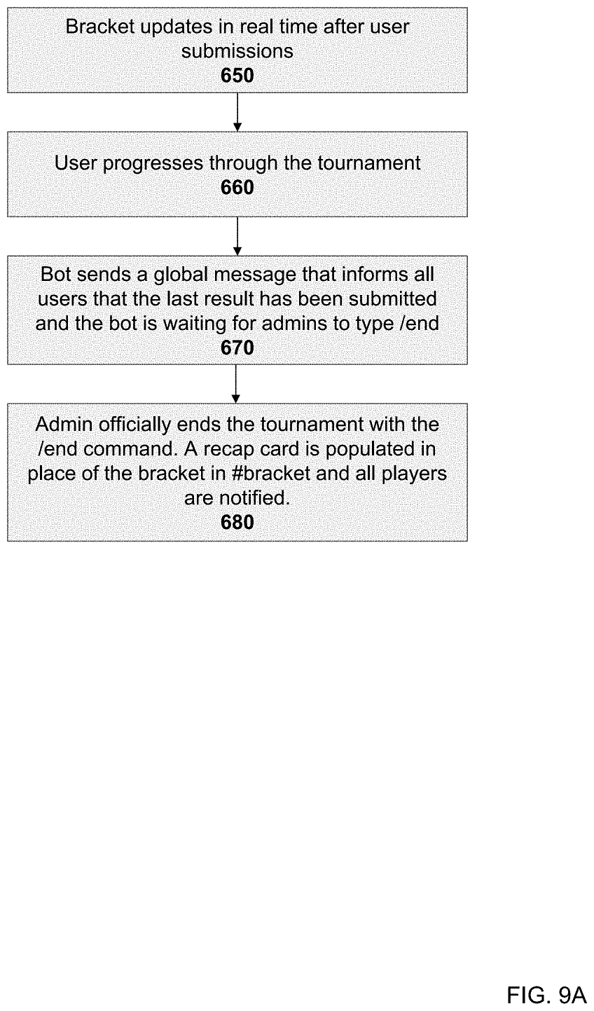

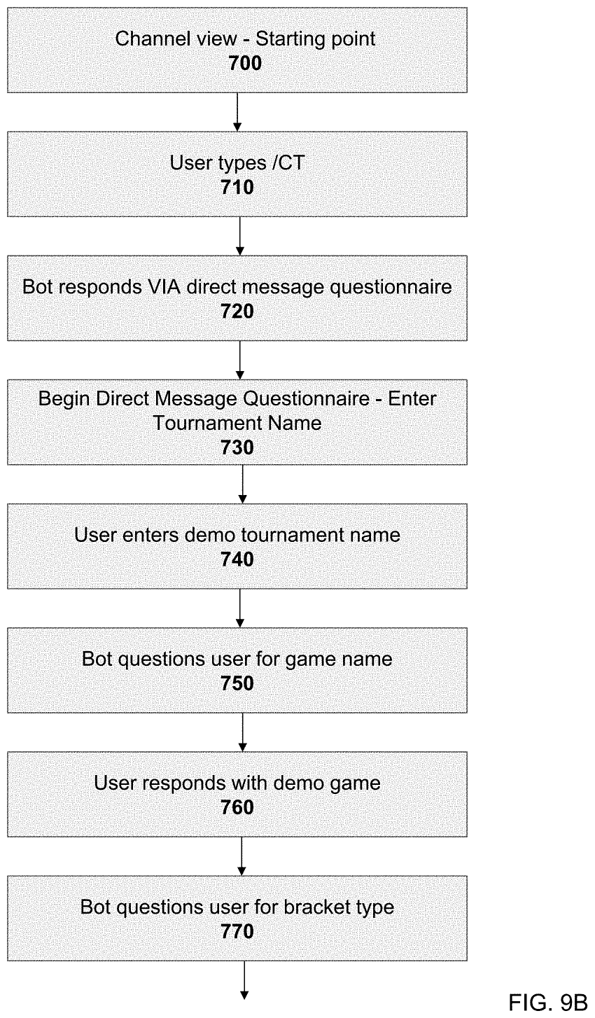

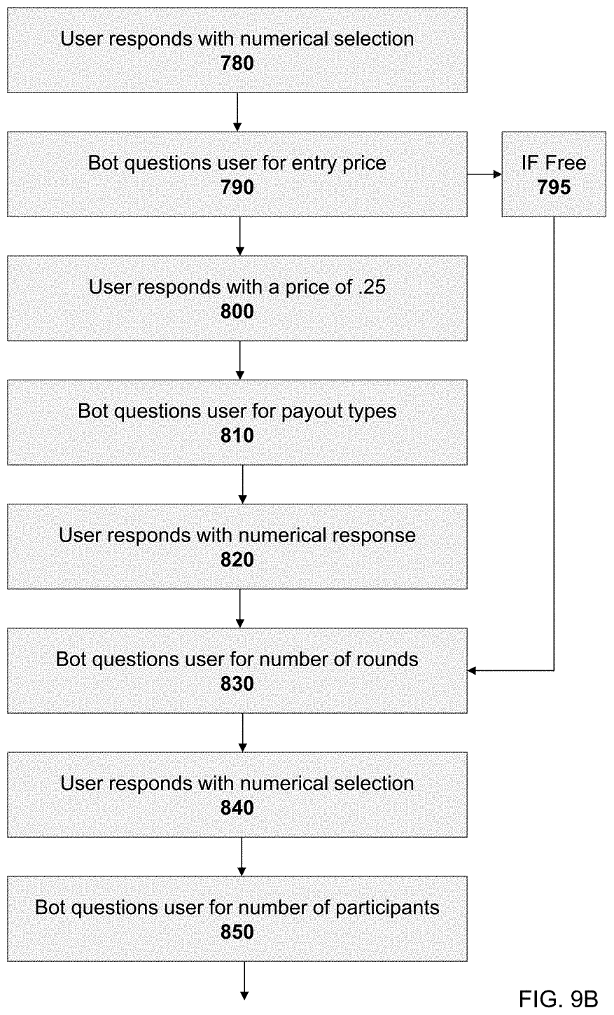

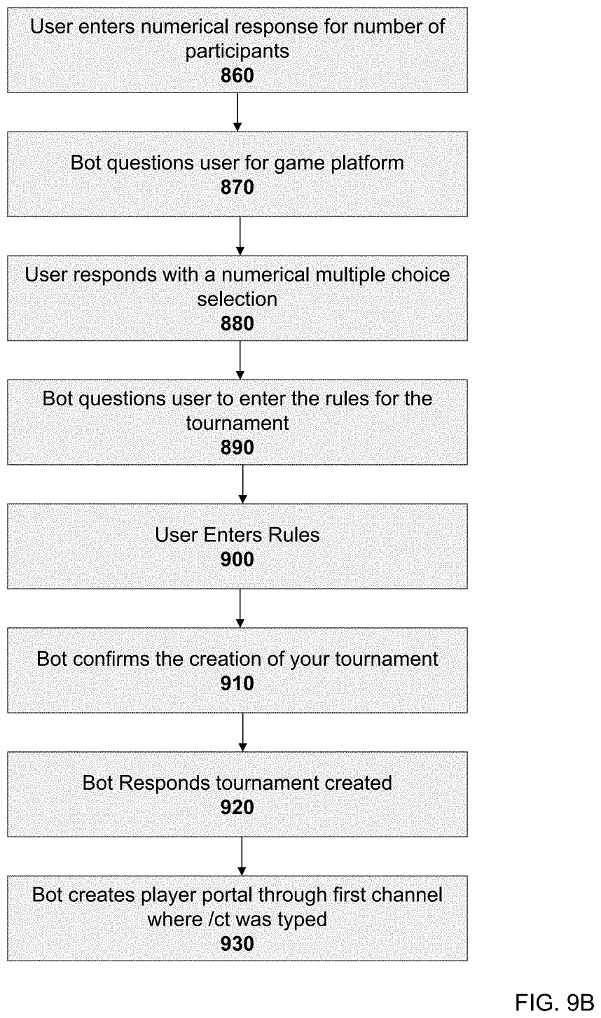

Referring now to FIGS. 9A-9B, various methods of conducting or facilitating automated tournaments are disclosed. In one embodiment, the method includes providing a user with a view of one or more channels 410. In another step, the user navigates to a tournament page 420 from the channel view 410. In yet another step, the user is directed to select a play button, icon or similar indicia 430, which causes a notification pop-up. In embodiments, this step occurs through the use of a recruitment bot or API. In yet another step, the bot is configured to determine whether the user has navigated to the tournament page for the first time, and if true displays a welcome message to the user 440, preferably along with additional information regarding the tournaments and other game play offered at the tournament page. In yet another step, the Discord or other server prompts the user to authorize collection of user data 450, such as contact information, user ID, avatar, username, etc. In another step, the bot directs the user to terms and conditions 460 as a condition precedent to joining a tournament. In yet another step, a thank you or similar message is displayed to the user 470, and instructions are preferably provided for joining a tournament. In yet another step, the user may navigate back to the tournament page or portal and join an event 480. In embodiments, the event is a paid entry tournament. In another embodiment, the event is a free tournament. In another step, the bot initiates a message and the user/player receives a notification 490. The notification may include an invitation for the user to establish an account and deposit funds in the account 500 for participation in, for example, a paid tournament. In another step, the user responds and makes a deposit in an existing or newly created account 510. In another step, the bot generates a checkout link for processing the deposit 520. In another step, Discord may send a message indicating the user is navigating away from the Discord server 530. In yet another step, Square, PayPal or another payment processor generates a shopping cart 540. Then, the user may perform the step of providing credit card or other personal information to complete the purchase through the payment processor 550. In another step, the user is provided with a transaction ID for the deposit or funds in the user's account 560. In another step, the bot sends a message to notify the user of the successful transaction 570. In yet another step, the user navigates back to the tournament page and joins an event 580. In another step, the user is provided with access to one or more channels 590 for further participation in different events. In yet another step, the bot sends a message to the user with the updated balance and report showing the amount of any deduction for participation in a paid event 600. In yet another step, the tournament administrator for a tournament selected by the user starts the tournament 610. In yet another step, the bot displays a message with the tournament bracket and chat channels for communicating with the other users and/or administrator of the tournament 620. In another step, the bot may display a bracket in a bracket channel for tournament players to utilize 630. In yet another step, a match or game is commenced and a user submits a score of the match or game to be placed on the bracket 640. In yet another step, the bracket is updated in or near real-time 650. In yet another step, the user(s) who advance from winning the match or game progress to yet a new match or game 660, consistent with the bracket. In yet another step, the bot sends a message that informs users in the tournament of the results as the matches/games progress 670. In yet another step, the administrator ends the tournament once all matches/games are completed and the final scores submitted 680, and preferably provides a recap of the results and an updated bracket for viewing.

Referring now to FIG. 9B, another method of the present disclosure includes the step of providing a user with a view of one or more channels 700. In another step, the user enters the /ct or /createtournament command 710 for creating a new tournament. In yet another step, a bot or API responds to the command 710 with a direct message questionnaire 720 to be completed by the user. In yet another step, the user enters information in response to the questionnaire and prompts received from the bot 730. In yet another step, the user enters a tournament name 740. In yet another step, the bot requests a game name from the user 750. In yet another step, the user responds with the game name 760. In another step, the bot requests a bracket type from the user 770. In yet another step, the user responds with a selection 780. In another step, the bot requests an entry fee or price for entering the tournament 790. In embodiments, if the event is free and the user enters “0” in response to step 790, the method proceeds to step 830. In not a free tournament, the user responds with the entry fee or price 800. In yet another step, the bot requests a payout type 810, and the user responds with the required information 820. In step 830, the bot requests the number of rounds from the user. In another step, the user responds with the number of rounds 840. In another step, the bot requests the number of participants 850, and the user may respond with the answer to this request 860. In another step, the bot requests the user to input the gaming platform 870. In yet another step, the user responds with the selection of the game platform 880. In yet another step, the bot requests rules for the tournament 890, and in another step the user supplies the rules 900. In yet another step, the bot confirms the creation of the tournament 910, and may send a message indicating the same to one or more users 920. In another step, the bot creates a player portal 930, including through the one or more channels where the tournament was created.

In the foregoing description, for the purposes of illustration, systems and methods were described in a particular order. It should be appreciated that in alternate embodiments, the methods may be performed in a different order than that described. It should also be appreciated that the methods described above may be performed by hardware components or may be embodied in sequences of executable instructions on machine-readable media, and which cause a machine, such as a general-purpose or special-purpose processor or logic circuits programmed with the instructions to perform the methods. These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, elements may be shown in flowcharts or block diagrams in order not to obscure the embodiments in unnecessary detail, but may not be present in other embodiments. In other instances, well-known elements, processes, algorithms, structures, and techniques may be shown without unnecessary detail in order to avoid obscuring the preferred embodiments.

Also, it is noted that the embodiments have been described as a process, which may depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the appended drawing figures. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the invention have been described in detail herein, it is to be understood that the inventive concepts may be otherwise variously embodied and employed, and that the appended claims are intended to be construed to include such variations, except as limited by the prior art. The invention illustratively disclosed herein suitably may be practiced in the absence of any element which is not specifically disclosed herein. It will be apparent to those skilled in the art that changes, variations, modifications, other uses, and applications of the invention are possible. Such changes, variations, modifications, other uses, and applications which do not depart from the spirit and scope of the invention are deemed to be covered by the invention.

The foregoing discussion of the invention has been presented for purposes of illustration and description. The foregoing is not intended to limit the invention to the form or forms disclosed herein. In the foregoing Detailed Description of the Invention, for example, various features of the invention are grouped together in one or more embodiments for the purpose of streamlining the disclosure. The features of the embodiments of the invention may be combined in alternate embodiments other than those discussed above. This method of disclosure is not to be interpreted as reflecting an intention that the invention requires more features than are expressly recited. Rather, inventive aspects lie in less than all features of a single foregoing disclosed embodiment.

Moreover, though the description of the invention has included description of one or more embodiments and certain variations and modifications, other variations, combinations, and modifications are within the scope of the invention, e.g. as may be within the skill and knowledge of those in the art, after understanding the present disclosure. It is intended to obtain rights which include alternative embodiments to the extent permitted, including alternate, interchangeable, and/or equivalent structures, functions, ranges, or steps to those described, whether or not such alternate, interchangeable, and/or equivalent structures, functions, ranges, or steps are disclosed herein, and without intending to publicly dedicate any patentable subject matter.

What is claimed is:

1. A system for facilitating tournament play among two or more members, comprising:
a. a tournament creation module;
b. a member portal;
c. a database, wherein the database is in communication with the tournament creation module and the member portal and configured to store:
i. member data;
ii. registration data;
iii. player data;
iv. team data;
v. tournament data;
vi. match data;
vii. score data;
viii. transactional and/or payout data;
ix. guild and/or server owner data; and
x. ranking and/or odds-related data
d. a scheduling module, wherein invitations may be sent to one or more members;
e. a bracketing module, wherein the system is configured to place members accepting invitations via the scheduling module are placed in a tournament bracket;
f. a match play module, wherein members assigned to matches may engage in competition and advance to subsequent matches in the tournament bracket;
g. a scoring module, wherein scores are reported by the members or captured by the conclusion of one or more matches completed in the match play module; and
h. a ranking module, wherein the member or members advancing to a predetermined rank, place or stage in the tournament bracket receive at least one transaction.

2. The system of claim 1 further comprising a dispute module, and wherein the database is further configured to store dispute data.

3. The system of claim 1 further comprising a financial transaction module configured to process financial transactions, account for disbursement of winnings and awards, and communicate transaction and/or payout data to the database.

4. The system of claim 1, wherein the system is configured to permit a quick match between any two users.

5. The system of claim 1, wherein the system is configured to permit messaging between at least two users.

6. The system of claim 1, wherein the system is configured to operate on Discord, Twitch, iOS or Android platforms.

7. The system of claim 1, wherein an administrator is allowed to customize one or more tournament features via the system, including tournament type, tournament entry, tournament game, tournament platform, tournament start requirement and tournament rules.

8. The system of claim 7 wherein the tournament type is selected from the group consisting of single elimination, double elimination, round-robin, swiss and quick match.

9. The system of claim 7 wherein the tournament is completed on a gaming system selected from the group consisting on Xbox, Playstation, and Steam.

10. The system of claim 7 wherein the administrator limits entry in the tournament to a number of users or for a limited period of time.

11. The system of claim 1, wherein the ranking module accounts for a plurality of variables, including skill set(s), pros/cons, attributes and past performance.
